(19) United States
(12) Patent Application Publication
(10) Pub. No.: US 2002/0131036 A1
(43) Pub. Date: Sep. 19, 2002

(54) Devices and methods for measuring residual stress in a membrane region of a segmented reticle blank

(75) Inventor: Shin-Ich Takahashi, Tokyo (JP)

Correspondence Address: KLARQUIST SPARKMAN, LLP, Suite 1600, One World Trade Center, 121 S.W. Salmon Street, Portland, OR, 97204, US

(73) Assignee: Nikon Corporation

(21) Appl. No.: 10/000,465

(22) Filed: Nov. 30, 2001

(30) Foreign Application Priority Data
Dec. 22, 2000 (JP) 2000-389823

(51) Int. Cl. G01B 11/16

(52) U.S. Cl. 356/32

(57) ABSTRACT

Methods and devices are disclosed for measuring residual stress in subfield membranes of selected subfields of a segmented reticle blank, such as would be used for fabricating a patterned reticle for use in charged-particle-beam microlithography. The reticle blank is mounted to a chamber configured to apply a gas pressure to the membrane of a selected subfield window of the reticle blank. The applied gas pressure can be changed as desired and is monitored. Meanwhile, a beam of probe light is irradiated onto the membrane. As the membrane exhibits a bulge from the applied pressure, light divergently reflected from the membrane surface is picked up by a photodetector such as a one-dimensional photodiode array. Data from the photodetector are routed to a computer that calculates the magnitude of bulge from the magnitude of divergence of reflected probe light detected by the photodetector. The measurement can be repeated after changing the gas pressure for the same subfield window and for other subfield windows, from which data the computer calculates the residual stress and Young's modulus of the reticle blank.

### FIELD

This disclosure pertains to microlithography (pattern transfer from a reticle to a sensitized substrate) using an energy beam such as a charged particle beam, X-ray beam or the like. More specifically, the disclosure pertains to “reticle blanks” (non-patterned reticles) that subsequently are inscribed with a pattern to be transferred by microlithography, and to methods and devices for evaluating internal stress in a reticle blank. Since “reticle” frequently is used interchangeably with “mask” in the art, it will be understood that “reticle” and “reticle blank” as used herein encompass “mask” and “mask blank,” respectively, as these terms are encountered in the art.

### BACKGROUND

As the density and level of integration of active circuit elements in microelectronic devices have continued to increase in recent years, the pattern-resolution limitations of optical microlithography have been increasingly apparent. Hence, substantial effort currently is being expended in the development of a practical “next-generation” microlithography technology. Whereas “optical” microlithography employs a beam of light (specifically, deep UV light) as the energy beam, “next-generation” microlithography approaches are based on use of a charged particle beam (e.g., electron beam or ion beam) or an X-ray beam as the energy beam. For charged-particle-beam (CPB) microlithography, a typical reticle configuration is a reticle membrane in which pattern features are defined as corresponding apertures in the membrane. Hence, such reticles are termed “stencil” reticles, in which the reticle membrane typically is a thin film of silicon. In this regard, reference is made to FIGS. 6(a)-6(b), depicting a schematic plan view and elevational section of a typical stencil reticle. The depicted reticle is formed from a silicon wafer 21 of a convenient and/or practical diameter (e.g., 6 to 12 inches). Due to the thinness and fragility of the reticle membrane, it currently is impossible to define the entire reticle pattern on an unsupported reticle membrane. Consequently, the reticle blank is divided (or “segmented”) into multiple subfields 23 each destined to define a respective portion of the overall pattern. On the reticle blank the subfields 23 are essentially respective portions of the reticle membrane that are separated from one another by support struts 22. The support struts 22 collectively form an intersecting grid providing substantial strength and rigidity to the reticle blank. Each subfield 23 typically has dimensions of <1 mm square to several mm square, and is situated as a respective “window” between respective adjacent struts 22. At the time the reticle blank is converted into an actual reticle, the desired pattern is divided as required to inscribe the respective portions of the pattern in the individual subfields of the reticle blank.

A conventional method for preparing a reticle blank is shown in FIGS. 7(a)-7(d). A “silicon-on-insulator” (SOI) wafer 24 is produced by a technique involving thermal lamination. The resulting SOI wafer 24, as shown in FIG. 7(a), comprises a support-silicon substrate 25, a silicon oxide layer 26, and a silicon layer 27. In FIG. 7(b), a layer of resist 28 is coated on the surface of the support-silicon substrate 25. The resist 28 is patterned lithographically so as to define respective locations of the subfield windows and the struts. The patterned resist 28 is dry-etched to expose regions 29, at which the subfields will be located, thereby forming a mask layer. (As an alternative to using the resist 28, a mask layer can be formed as a patterned layer of silicon oxide (having a thickness of several μm.) The regions of the silicon-support substrate 25 “exposed” by the mask layer are dry-etched, wherein the mask layer is used as an etching mask. Etching progresses through the thickness of the silicon-support substrate 25 to the silicon oxide layer 26. Because silicon oxide is relatively unaffected by dry-etching conditions, etching stops at the silicon oxide layer 26, thereby leaving window-shaped regions 30 each spanned by a residual thin film of silicon oxide 26 and silicon 27 (FIG. 7(c)). The residual silicon oxide layer 26 in each window 30 is removed using, for example, a mixed solution of ammonium fluoride and hydrofluoric acid. The result is shown in FIG. 7(d), in which each window has a respective membrane portion consisting of the remaining silicon layer 27. The product shown in FIG. 7(d) is the “reticle blank” because it has not yet been inscribed with the reticle pattern. To complete fabrication of an actual reticle, the membrane portions 27 of the subfields are patterned with respective portions of a pattern. As an alternative, the pattern may be inscribed in the silicon layer 27 before commencing the step shown in FIG. 7(a).

In the process shown in FIGS. 7(a)-7(d), the SOI wafer 24 is formed by a technique involving heating the silicon-support substrate 25 (with applied silicon oxide layer 26 and silicon layer 27) to a temperature of about 1200° C. to achieve thermal lamination of the layers. Due to substantial differences in the thermal expansion coefficients of the silicon layer 27 and the silicon oxide layer 26, residual thermal compressive stresses remain in the silicon layer 27 after cooling the laminated structure to room temperature. These residual stresses cause bending and other deformations of the membrane portions of the reticle blank. Whenever the membrane portions have residual stresses, deformation of the respective pattern portions is likely after the reticle blank has been made into a reticle. Various approaches have been investigated for controlling membrane deformations due to residual stresses. Hence, the extreme importance of being able reliably to measure residual stresses in reticle blanks has become apparent.

Conventionally, “bulge” techniques are used for measuring internal stress and Young's modulus of self-standing thin films. The principles of bulge techniques are explained briefly below. Using a bulge technique, it is possible to simultaneously determine the residual internal stress and the Young's modulus of a self-standing thin film from data concerning the magnitude of thin-film deformation observed whenever a static load is applied to the film. The total elastic energy when a load is applied to the thin film is expressed as a sum of the strain energy due to the load and the strain energy attributable to internal stress. The total elastic energy is stable under conditions in which the total of the elastic energy is equal to the energy of the pressure. This relationship is expressed as follows:

P =C₁σth/a²+C₂Eth³/a⁴ (1)

wherein P is the applied pressure to the thin film, σ is the internal stress of the film, t is the film thickness, h is the magnitude of bulging, a is the length of one side of the film window, E is the Young's modulus of the film, and C₁ and C₂ are constants determined from the window shape of the self-standing thin film and Poisson's ratio. The first term on the right side of the equation (i.e., the term including C₁) corresponds to the elastic energy of the film due to internal stress, the second term on the right corresponds to the elastic energy of the film due to pressure deformation, and the left-side term corresponds to the energy of the pressure. As can be discerned from Equation (1), it is possible to determine the internal stress and the Young's modulus of a thin film simultaneously by measuring the magnitude of bulge of the thin film resulting from application of pressure to the thin film or resulting in a change in the applied pressure. In general, the magnitude of bulge decreases as Young's modulus is increased. Similarly, the magnitude of bulge is lower with higher internal stress in the thin film.

A block diagram of a conventional apparatus for experimentally determining internal stress and Young's modulus of a thin film is shown in FIG. 8. A measurement sample 32 is installed at the upper portion of a pressure-adjustment chamber 31. Regions of contact of the measurement sample 32 with the pressure-adjustment chamber 31 are sealed tightly using an O ring 33 or the like. The measurement sample 32 is mounted such that its corners are supported by a cinching plate 35 secured by screws 34. A pressure-adjustment device 36 desirably is regulated so as to provide an accurate and stable pressure inside the chamber 31. The chamber 31 includes a pressure gauge 37 used for continually monitoring the pressure inside the chamber. The magnitude of bulge of the measurement sample 32 is measured by a device 38 that exploits any of several conventional measurement techniques. (The bulge is measured as the pressure in the chamber 31 is changed by the pressure-adjustment device 36.) These measurement techniques include film-surface palpation using a contact probe, film-surface analysis using a non-contacting interferometer, or film-surface scanning using a microscope having a Z-direction micrometer. From data obtained by the bulge-measurement device 38, the internal stress and Young's modulus of the subject thin film are obtained by substituting the measurement data into Equation (1).

Unfortunately, the conventional bulge-measuring approach shown in FIG. 8 has substantial limitations and problems. For example, whenever bulge is measured using film-surface palpation, the film is deformed by applied contact pressure of the contact probe; thus, it is difficult to measure the actual magnitude of bulge corresponding to a certain applied pressure in the chamber 31. Using a non-contacting interferometer to measure film bulge is very slow; more than 10 seconds are required to obtain a bulge measurement at a single point on the film. Hence, an extremely large amount of time is required for measuring an entire reticle blank. Also, at the start of making such measurements, sophisticated alignments of the measurement sample 32 are required, necessitating use of a sample stage having four axes of adjustability. Substantial time also is required whenever bulge measurements are obtained using a microscope equipped with a micrometer; also, automation of this technique is problematic.

### SUMMARY

In view of the shortcomings of conventional methods and devices as summarized above, the present invention provides, inter alia, reticle-blank measurement devices and methods that allow bulge measurements to be obtained at high throughput, even when applied to measurements of the entire reticle blank.

According to a first aspect of the invention, methods are provided for determining internal stress of a membrane of a reticle blank. In an embodiment of such a method, a measured gas pressure is applied to one side of the membrane so as to cause the “other” side of the membrane to exhibit a corresponding convex bulge. A beam of probe light is directed to a location on the bulge such that the probe light reflects from the bulge. The resulting divergence of the reflected probe light is measured. From data concerning the divergence and of the corresponding gas pressure, the internal stress of the membrane is determined.

In the foregoing method, the step of applying a measured gas pressure can comprise mounting the reticle blank on a pressure chamber that is movable in X and Y directions and that defines an interior space, and applying a known gas pressure to the interior space. In addition, the step of directing the beam of probe light can comprise directing a laser beam (or other collimated beam) to the location on the bulge.

Normally, the reticle blank is a segmented reticle blank comprising multiple subfield windows each comprising a respective membrane portion. With such a reticle blank, multiple measurements of divergent probe light usually are performed at different respective applied pressures for each of multiple subfield windows of the reticle blank.

According to another aspect of the invention, devices are provided for determining internal stress of a membrane of a reticle blank. An embodiment of such a device comprises a chamber that defines an interior space and that is configured to receive a reticle blank such that a gas pressure applied to the interior space is applied to one side of the membrane of a selected region of the reticle blank. As a result of the applied pressure, the “other” side of the membrane exhibits a corresponding bulge. A pressure sensor (e.g., pressure gauge) is connected to the chamber and is configured to produce data concerning the applied selected pressure in the interior space. An illumination system is situated and configured to receive a beam of probe light and to direct the probe light onto the bulge. A photodetector is situated and configured to receive light, of the probe light reflected from the bulge, and to measure a distribution of divergence of the reflected light. A computer is connected to the photodetector and pressure sensor. The computer is configured to compute a magnitude of bulge deformation of the membrane from data, from the photodetector, concerning a corresponding magnitude of divergence of reflected probe light. The computer also is configured to compute an internal stress of the membrane from data, from the pressure sensor, concerning multiple measured pressures and from the computed magnitudes of membrane deformation.

The gas pressure in the interior space of the chamber desirably is supplied by a regulated source connected to the computer. In this configuration, the computer is further configured to regulate, via the regulated source, the gas pressure in the interior space based on pressure data routed to the computer by the pressure sensor.

The illumination system desirably comprises a semitransparent mirror situated to receive the beam of probe light and to direct the beam at a normal angle of incidence to the bulge in the membrane. The light reflected from the bulge passes through the semitransparent mirror to the photodetector.

The chamber can be mounted on an X-Y stage connected via a stage controller to the computer. In such a configuration, the computer is configured to actuate movement of the X-Y stage in a controllable manner as required to select a particular subfield window of the reticle blank for measurement. Alternatively, the chamber can be held stationary while the illumination system used to irradiate the bulge with probe light is movable in X- and Y-directions.

A notable feature of the disclosed embodiments is the detection and measurement of divergence of a beam of probe light reflected from a bulge in the membrane of a selected subfield window. Using certain relationships between the magnitude of bulge of the membrane caused by the gas pressure and the divergence of the reflected light, an optical lever principle is exploited. This optical lever principle allows small magnitudes of bulge and other membrane deformations (including bulges and deformations affected by residual stress in the membrane) to be measured quickly and with high accuracy. The obtained measurement accuracy is substantially better than obtainable using conventional methods and devices. Also, because the bulge measurements can be obtained quickly, throughput is higher using methods and devices as disclosed herein than obtained using conventional methods. From the measurements of bulge and the like, calculations can be made of residual stress as well as the Young's modulus of the membrane portions of the reticle blank.

Desirably, to obtain reliable stress measurements of the reticle blank, gas pressure as applied to the membrane is measured accurately at multiple applied pressures. Further desirably, similar measurements are obtained of the respective membranes of multiple subfields of the reticle blank. During each bulge measurement, the corresponding divergence of probe light reflected from the convex surface of the bulge is measured. This measurement desirably is performed simultaneously with measuring the applied pressure.

The foregoing and additional features and advantages of the invention will be more readily apparent from the following detailed description, which proceeds with reference to the accompanying drawings.

### BRIEF DESCRIPTION OF THE DRAWINGS

FIG. 1 is a schematic block diagram of a representative embodiment of a device for evaluating residual stress in a reticle blank.

FIG. 2 is a plot of exemplary data depicting the relationship between applied pressure and the magnitude of bulge of the membrane of one subfield of the reticle blank.

FIG. 3 is a diagram showing general principles of the optical lever utilized in the device embodiment of FIG. 1.

FIG. 4(a) is a schematic plan view of the membrane of a single subfield of a reticle blank, depicting the manner in which the membrane bulges upon application of pressure.

FIG. 4(b) is a plan contour diagram of reflected probe light from the membrane of FIG. 4(a) as projected onto a screen or the like irradiated by the reflected probe light.

FIG. 5 is a plot of exemplary data of the angle of light divergence versus membrane bulge.

FIG. 6(a) is a schematic plan view of a conventional segmented reticle blank.

FIG. 6(a) is a schematic elevational section of the reticle blank of FIG. 6(a).

FIGS. 7(a)-7(a) are schematic elevational sections showing the results of respective steps in a conventional process for manufacturing a reticle blank such as that shown in FIGS. 6(a)-6(a).

FIG. 8 is a schematic elevational view of a conventional device for measuring internal stress and Young's modulus of a thin film.

### DETAILED DESCRIPTION

Various aspects of the invention are described below in the context of representative embodiments, which are not intended to be limiting in any way.

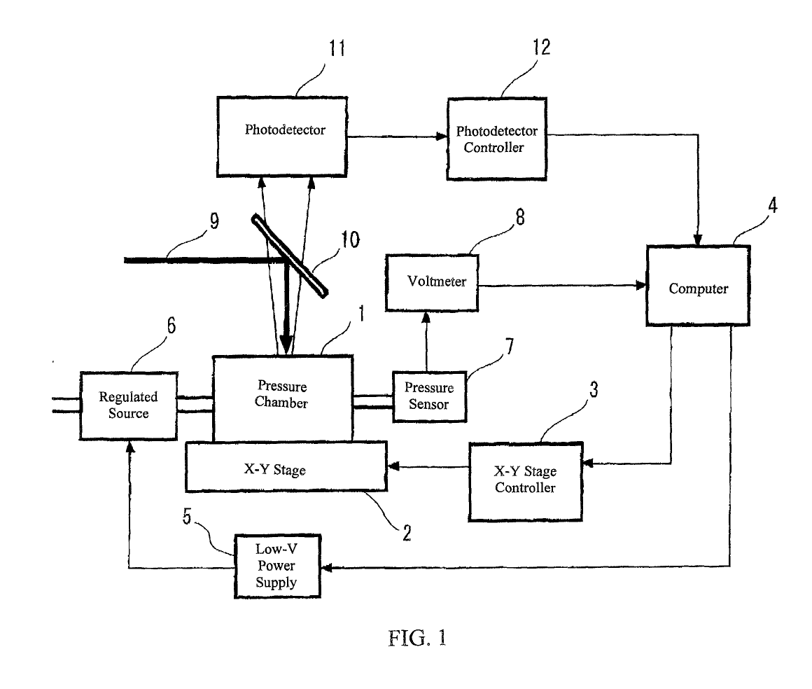

A first representative embodiment of a device for measuring residual stress in a thin film of a reticle blank is depicted schematically in FIG. 1. The device of FIG. 1 includes a chamber 1 mounted on an X-Y stage 2. The X-Y stage 2 is connected to and controlled by an X-Y stage controller 3 that is connected to a computer 4 (e.g., “personal” computer). Connected to the chamber 1 is a regulated pressure source 6 energized by a low-voltage power source 5 under control of the computer 4. Also connected to the chamber 1 is a pressure sensor 7 (e.g., pressure gauge) that is connected to a voltmeter 8 (or other suitable interface device that performs signal conversion such as analog-to-digital conversion). The reticle blank (not detailed) is placed on the chamber 1 in a manner allowing a beam 9 of “probe” light (typically a beam of laser light) to be incident on the surface of the reticle blank. The beam 9 desirably is a collimated beam that is produced by a source (typically a laser) and propagates through a probe-light optical system that comprises a semitransparent mirror 10. The beam 9 reflects from the semitransparent mirror 10 as the beam propagates to the surface of the reticle blank, on which the beam 9 desirably has a normal (0°) angle of incidence. Probe light reflected from the reticle blank passes through the semitransparent mirror 10 to a one-dimensional photodetector 11 that is connected to and controlled by a photodetector controller 12.

As noted above, the subject reticle blank is mounted to the top (in the figure) of the chamber 1, which (in this embodiment) is mounted to the X-Y stage 2. The X-Y stage 2 is controlled by the computer 4 via the X-Y stage controller 3. The chamber 1 defines an interior space containing a gas and in which the gas pressure is under control of the computer 4. I.e., the computer 4 controls a voltage, generated by the low-voltage power source 5, delivered to the regulated pressure source 6, which pressurizes the interior space of the chamber 1 accordingly. Thus, the regulated pressure in the chamber 1 is a function of the voltage applied to the regulated pressure source 6. By changing the pressure within the chamber 1, the pressure applied to the subject reticle blank is varied. The pressure within the chamber 1 is measured by the pressure sensor 7, and the measurement data thus obtained are converted to corresponding voltage data that are input to the computer 4 via the voltmeter 8.

Probe light reflected from the membrane surface of the reticle blank is changed according to the magnitude of the bulge of the membrane. The reflected probe light is detected by the photodetector 11. The photodetector 11 can be, for example, a one-dimensional photodiode array or a two-dimensional image detector. Data generated by the photodetector 11 is converted appropriately by the photodetector controller 12 and routed to the computer 4 for processing.

As discerned from the discussion above, the computer 4 controls the entire depicted system, including data acquisition and data processing (including arithmetical calculations involving the data). By controlling the output of the power supply 5, the computer 4 also controls the initial pressure applied by the regulated pressure source 6 to the interior space defined by the chamber 1, as discussed above. The initial pressure in the chamber 1 is measured by the pressure sensor 7. Data from the pressure sensor 7 are input to the computer 4 via the voltmeter 8, and stored in a memory in the computer 4.

Meanwhile, the beam 9 is irradiated continuously on the surface of the membrane of the selected subfield window, as probe light reflected from the membrane surface is detected by the photodetector 11. Data concerning the intensity distribution of the probe light reflected from the membrane, as detected by the photodetector 11 (e.g., a one-dimensional photodetector), is input to the computer 4 via the photodetector controller 12. These data include data concerning the width of the distribution of probe light reflected from the membrane surface. From these data the computer 4 computes the magnitude of bulge of the membrane. The results of the computations are stored in the computer's memory in association with corresponding pressure data. Thus, a profile of bulging of the membrane of a selected subfield window is determined and recorded. Data acquisition for a subfield is completed by recording, in this manner, bulge data at various applied pressures in the chamber 1.

After completing data acquisition for a first subfield, the X-Y stage 2 is moved (under control of the computer 4) to present a second prescribed subfield window of the reticle blank to the beam 9. Measurements are obtained of the second subfield in the same manner as obtained for the first subfield. Subsequent subfields are measured in the same manner until the entire reticle blank is evaluated.

From this data, the computer 4 determines the film “quality” (residual internal stress and Young's modulus) for each selected subfield window of the reticle blank. These computations are performed by fitting the respective measurement data into Equation (1) using the method of least squares.

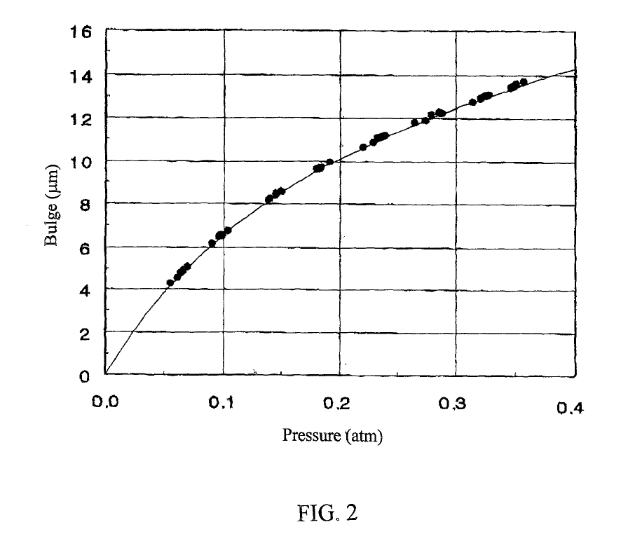

Exemplary data for the membrane of a single subfield window are plotted in FIG. 2, in which the abscissa is applied pressure, and the ordinate is the corresponding magnitude of bulge of the respective membrane spanning the subfield window. From the plotted data, the profile of increased bulge with increased pressure can be ascertained. For example, in FIG. 2, the solid-line curve is of fitted data. From the depicted plot, it can be seen that the curve-fitting computation can be performed with good accuracy.

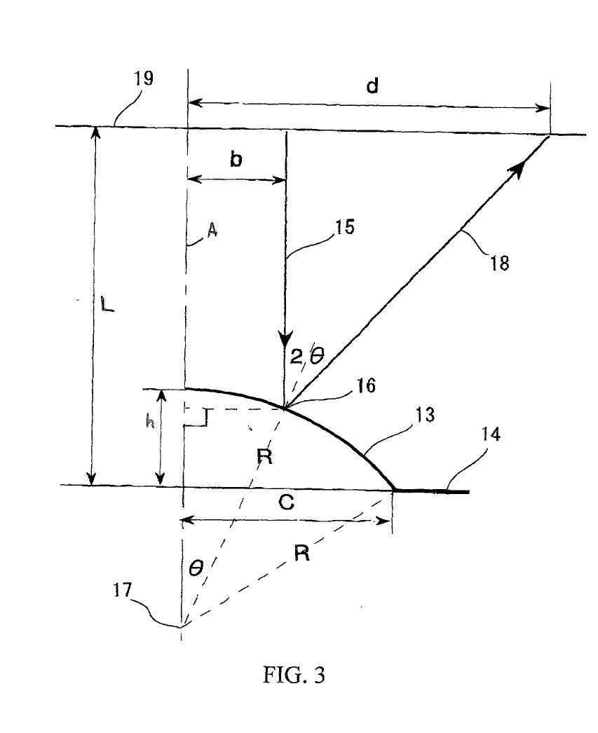

The principles associated with irradiating the membrane with a beam of probe light and with determining membrane bulge from probe light reflected from the membrane of a selected subfield window are shown in FIG. 3. In FIG. 3, the membrane is irradiated and pressurized using a device such as shown in FIG. 1. In FIG. 3, item 13 is a bulged region of the membrane of the subfield window, and item 14 is the substrate of the reticle blank. Probe light 15 propagates downward in the figure along a propagation axis A and is incident on the membrane at a locus 16. (The locus 16 actually is the intersection of the membrane with the outermost edge of the incident beam of probe light.) Item 17 is the center of the curvature radius of the membrane bulge, item 18 is the outer edge of the divergent beam of probe light reflected from the membrane, and item 19 is a “projection plane” (i.e., a plane defined by a screen or the like irradiated by the reflected probe.

In FIG. 3, only the right half of the membrane 13 associated with the selected subfield window is shown. I.e., the depicted half extends from the propagation axis A to the point of intersection of the bulged membrane 13 with the substrate 14. Hence, from the figure, the length of a side of the subfield is 2C. In the figure, the membrane 13 is assumed to be deformed by the applied pressure in a manner such that the “upper” surface is convex (with a respective curvature radius R). Whenever a beam of probe light 15 (the beam having a radius b) is incident perpendicularly to the plane of the substrate 14, the bulging convex surface of the membrane 13 acts as a spherical mirror that produces a divergent beam of reflected light 18, as shown in the figure. At the point 16, a line normal to the curved surface 13 intersects the propagation axis A at the point 17 and defines an angle 0. Thus, incident probe light 15 reflects from the point 16 at an angle of divergence of 20. The photodetector 11 is situated at the projection plane 19. The width of divergence of the reflected probe light at the projection plane 19 is d, and the distance from the substrate 14 to the projection plane 19 is L. The magnitude of bulge h of the center of the membrane is expressed approximately by Equation (2), below.

$$h = \frac{2 bL}{d} - \sqrt{{( \frac{2 bL}{d} )}^{2} - {( \frac{C}{2} )}^{2}} \qquad ( 2 )$$

wherein h, b, L, d, and C are as defined above.

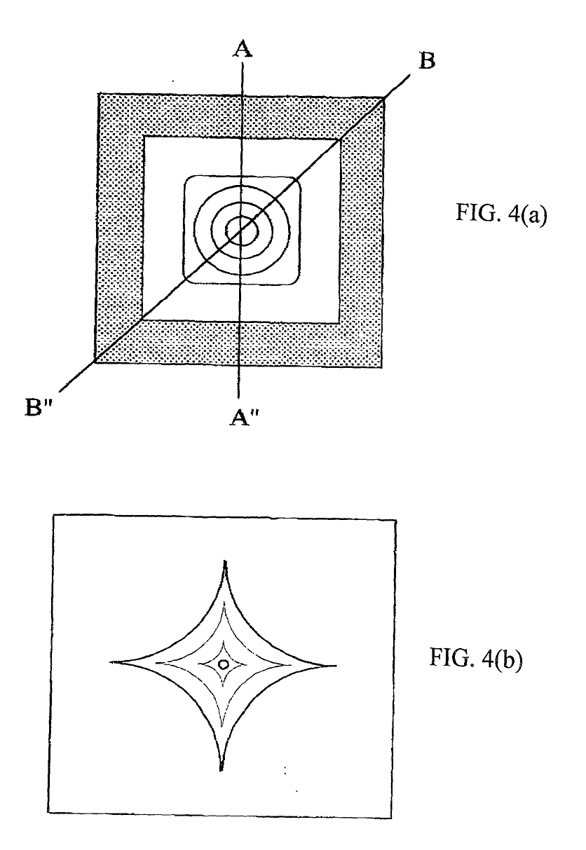

FIG. 4(a) schematically depicts an exemplary bulge of the membrane of a square subfield window whenever pressure is applied to the membrane of the subfield. FIG. 4(a) schematically depicts an exemplary reflected beam as projected from the membrane of FIG. 4(a) onto a screen, for example, at the projection plane 19. The bulge of the membrane is represented by contour lines in FIG. 4(a). At the top of FIG. 4(a), the angle of incline of the section line A-A″ is steeper than the angle of incline of the section line B-B″. Hence, the angle of divergence of probe light (and the width of reflected light at the projection plane 19) from the membrane is larger along the line A-A″ than along the line B-B″. As shown in FIG. 4(a), a star-shaped projection image is produced. (In the discussion above concerning the width of the divergent beam at the projection plane, as diagrammed in FIG. 3, probe light along the line A-A″ is shown in FIG. 3.)

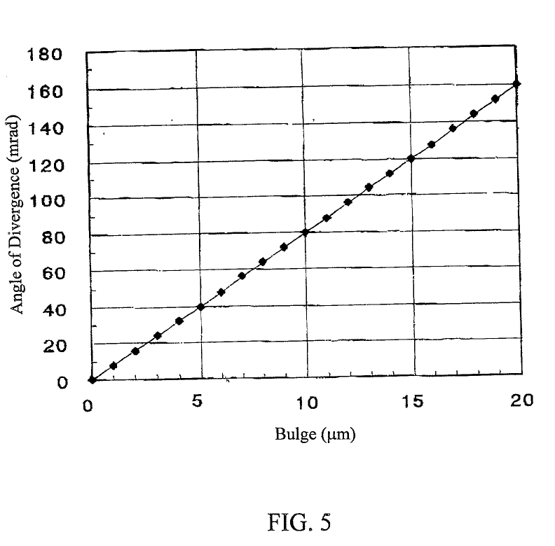

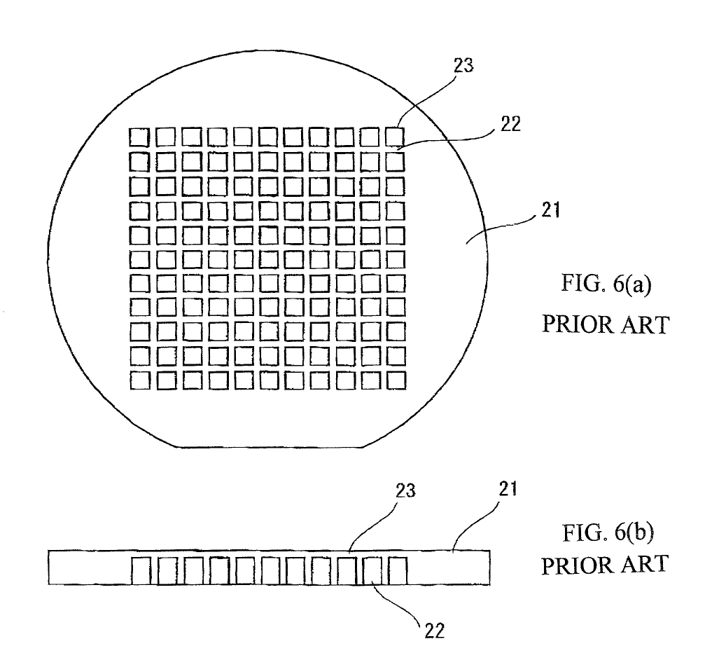

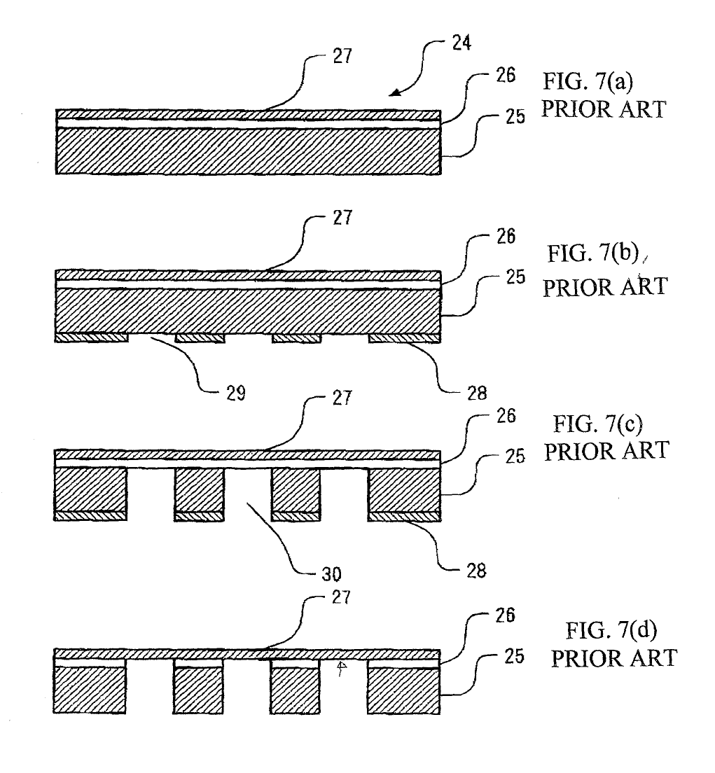

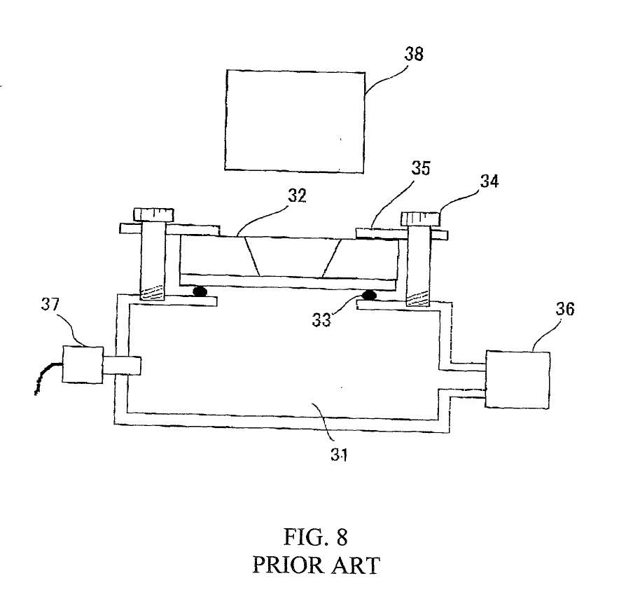

Exemplary results of a calculation based on the divergence of reflected probe light are shown in FIG. 5. The data are plotted as angle of divergence on the ordinate and magnitude of bulge on the abscissa. The incident beam of probe light was 1 mm in diameter and the membrane of the subfield window was 1-mm square. FIG. 5 indicates that a beam-divergence angle of approximately 80 mrad is produced by a bulge of 10 μm. The corresponding width of divergence is approximately 23 mm whenever L=138 mm. By way of example, if the photodetector 11 is a 1024-channel one-dimensional detector (wherein each channel has a width of 25 μm), then the resolution with which a bulge measurement is performed by any one channel is approximately 0.1 μm. When bulge data are converted to a corresponding value of membrane stress, the corresponding accuracy is approximately ±1 MPa. Hence, it can be seen that residual stress determinations can be obtained at very high accuracy using a simple device. It will be understood that the accuracy with which the divergent width of the beam is measured increases with increasing length L.

Therefore, bulge of a thin membrane such as associated with a selected subfield window of a reticle blank is measured at high accuracy using a simple device that operates on the principle of an optical lever. The device also permits bulge measurements (with corresponding conversions to measurements of residual internal stress and Young's modulus of the membrane) to be obtained quickly and at high throughput.

Whereas the invention has been described in connection with representative embodiments, it will be understood that the invention is not limited to those embodiments. On the contrary, the invention is intended to encompass all modifications, alternatives, and equivalents as may be included within the spirit and scope of the invention, as defined by the appended claims.

What is claimed is:

1. A method for determining internal stress of a membrane of a reticle blank, comprising:
applying a measured gas pressure to one side of the membrane so as to cause the membrane to exhibit a corresponding bulge on an other side of the membrane;
directing a beam of probe light to a location on the bulge such that probe light reflects from the bulge;
measuring a divergence of the reflected probe light; and
from data concerning the divergence and of the corresponding gas pressure, determining the internal stress of the membrane.

2. The method of claim 1, wherein the step of applying a measured gas pressure comprises:
mounting the reticle blank relative to a pressure chamber that is movable in X and Y directions and that defines an interior space, such that application of the measured gas pressure to the interior space results in application of the gas pressure to the reticle blank; and
applying a known gas pressure to the interior space.

3. The method of claim 2, wherein the selected region is a respective membrane of a selected subfield window of the reticle blank.

4. The method of claim 1, wherein the step of directing the probe light beam comprises directing a laser beam to the location on the convex other side.

5. The method of claim 4, wherein the probe light beam is incident at a normal angle of incidence on the location.

6. The method of claim 1, wherein:
the reticle is a segmented reticle comprising multiple subfield windows each comprising a respective membrane portion; and
multiple measurements of divergent light are performed at different respective applied pressures for each of multiple subfield windows of the reticle blank.

7. A device for determining internal stress of a membrane of a reticle blank, comprising:
gas-pressure-application means for applying a selected gas pressure to the membrane;
pressure-measurement means for measuring the applied selected pressure;
probe-light-irradiation means for irradiating a beam of probe light onto the membrane to which the gas pressure is being applied;
light-distribution-measurement means for measuring a magnitude of divergence of a reflected light beam produced by reflection of the probe light beam from the membrane;
membrane-deformation-calculation means for computing a magnitude of deformation of the membrane from data concerning a corresponding magnitude of divergence; and
membrane-stress-computation means for computing an internal stress of the membrane from data concerning multiple measured pressures and data concerning corresponding magnitudes of membrane deformation.

8. A device for determining internal stress of a membrane of a reticle blank, comprising:
a chamber defining an interior space and configured to receive a reticle blank such that a gas pressure applied to the interior space is applied to one side of the membrane of a selected region of the reticle blank;
a pressure sensor connected to the chamber and configured to produce data concerning the applied pressure in the interior space;
an illumination system situated and configured to receive a probe-light beam and to direct the probe-light beam onto an other side of the membrane opposite the side to which the gas pressure is being applied;
a photodetector situated and configured to receive light, of the probe-light beam, reflected from the other side of the membrane, and to measure a distribution of divergence of the probe light as reflected from the other side; and
a computer connected to the photodetector and pressure sensor, the computer being configured to compute a magnitude of deformation of the membrane from data, from the photodetector, concerning a corresponding magnitude of divergence of reflected probe light, and to compute an internal stress of the membrane from data, from the pressure sensor, concerning multiple measured pressures and from data concerning corresponding magnitudes of membrane deformation.

9. The device of claim 8, wherein;
the gas pressure in the interior space of the chamber is supplied by a regulated pressure source connected to the computer; and
the computer is further configured to regulate, via the regulated pressure source, the gas pressure in the interior space based on pressure data routed to the computer by the pressure sensor.

10. The device of claim 9, wherein the regulated source is connected to the computer via a low-voltage power supply.

11. The device of claim 8, wherein:
the illumination system comprises a semitransparent mirror situated to receive the probe-light beam and to direct the probe-light beam at a normal angle of incidence to the other side of the membrane; and
the probe light reflected from the other side of the membrane passes through the semitransparent mirror to the photodetector.

12. The device of claim 8, wherein the illumination system comprises an optical system configured as an optical lever that directs the probe-light beam to be incident as a collimated beam on the other side of the membrane and that directs divergent probe light reflected from the membrane to the photodetector.

13. The device of claim 8, wherein:
the chamber is mounted on an X-Y stage connected via a stage controller to the computer; and
the computer is configured to actuate movement of the X-Y stage as required to select a particular subfield window of the reticle blank for measurement.
